(19) United States
(12) Patent Application Publication
(10) Pub. No.: US 2017/0031537 A1
(43) Pub. Date: Feb. 2, 2017

(54) DISPLAY METHOD AND ELECTRONIC DEVICE

(71) Applicants: Beijing Lenovo Software Ltd., Beijing (CN); Lenovo (Beijing) Co., Ltd., Beijing (CN)

(72) Inventors: Yan CHEN, Beijing (CN); Shu GAO, Beijing (CN); Xuling XU, Beijing (CN)

(73) Assignees: Beijing Lenovo Software Ltd., Beijing (CN); Lenovo (Beijing) Co., Ltd., Beijing (CN)

(21) Appl. No.: 14/937,127

(22) Filed: Nov. 10, 2015

(30) Foreign Application Priority Data
Jul. 27, 2015 (CN) 201510445621.5

(51) Int. Cl. G06F 3/0482; G06F 9/44; G06F 3/0481

(52) U.S. Cl. CPC G06F 3/0482; G06F 3/04817; G06F 9/4443

(57) ABSTRACT

A display method is provided. Multiple application identifications of multiple application programs being running are displayed in queues on a display screen of an electronic device based on an instruction for calling a task manager generated via a first input operation. N object identifications are displayed in a second area of the display screen in a case that a first application identification is displayed in a first area of the display screen; the N object identifications correspond to N application programs, the N application programs are associated with a first application program corresponding to the first application identification. A number of application programs being currently running in the electronic device are displayed in a page of the task manager; and the application programs associated with an application program being running are directly displayed in a case that the application program being running is selected.

### CROSS REFERENCE OF RELATED APPLICATION

The present application claims the priority to Chinese Patent Application No. 201510445621.5, titled “DISPLAY METHOD AND ELECTRONIC DEVICE”, filed on Jul. 27, 2015 with the State Intellectual Property Office of the People's Republic of China, the content of which is incorporated herein by reference in its entirety.

### FIELD

The present disclosure relates to the field of electronic devices, and more particularly to a display method and an electronic device.

### BACKGROUND

With the development of electronic technology, more and more application programs are developed for use. Some application programs have like or similar functions, and a user usually selects one from several application programs for operation when the user uses an electronic device.

In the conventional technology, FIG. 1 shows a schematic diagram of the display of icons for application programs in an electronic device. The icons are displayed on a desktop or an application icon page of the electronic device. FIG. 1(a) shows a scheme of displaying an application icon “A” on the desktop of the electronic device, and FIG. 1(b) shows a scheme of displaying the application icon “A” in the application icon page of the electronic device.

In the conventional technology, if the user wants to use other application programs associated with functions of the application program “A” during the usage of the application program “A” of the electronic device, the user needs to exit from the interface of the application program “A” and access an icon display page of the electronic device, determine a target application program “B” associated with the functions of the application program “A” in the icon display page according to own historical operation experience, and click the icon for the application program “B”, thereby opening the application program “B”.

In the process, the user needs to perform multiple operations, the operation steps are complex, and the user has a poor experience.

### SUMMARY

In view of this, a display method is provided, so as to solve the problem in the conventional technology that other application programs associated with functions of an application program are opened by a user with complex operation steps.

In order to achieve the above object, the disclosure provides the following technical solutions.

A display method is provided, which includes: generating an instruction for calling a task manager according to an obtained first input operation; displaying M application identifications of M application programs being running in queues on the display screen of an electronic device based on the instruction for calling a task manager, where M is a positive integer greater than or equal to 1; and displaying N object identifications in a second area of the display screen in a case that a first application identification is displayed in a first area of the display screen. The N object identifications correspond to the N application programs, the N application programs are associated with the first application program corresponding to the first application identification, where N is a positive integer greater than or equal to 1; an application program corresponding to each of the M application identifications is called in response to a first triggering operation, and an application program corresponding to each of the N object identifications is called in response to a second triggering operation.

Preferably, before the generating an instruction for calling a task manager according to an obtained first input operation, the method further includes: acquiring each of at least two of the application programs in the electronic device as a target application program; screening, according to the target application program, N application programs which meet a preset association condition from at least one of the application programs except the target application program in the electronic device; and associating the target application program with the N application programs.

Preferably, after the displaying M application identifications of M application programs being running in queues on the display screen of the electronic device based on the instruction for calling a task manager and before the displaying N object identifications in the second area of the display screen, the method further includes: acquiring each of the M application programs as a target application program; screening, according to the target application program, N application programs which meet a preset association condition from at least one of the application programs except the target application program in the electronic device; and associating the target application program with the N application programs.

Preferably, after the displaying M application identifications of M application programs being running in queues on the display screen of the electronic device based on the instruction for calling a task manager and before the displaying N object identifications in the second area of the display screen, the method further includes: adjusting a display area for the first application identification in the M application identifications into the first area of the display screen according to an obtained second input operation; acquiring a target application program corresponding to the first application identification; screening, according to the target application program, N application programs which meet a preset association condition from at least one of the application programs except the target application program in the electronic device; and associating the target application program with the N application programs.

Preferably, the displaying N object identifications in the second area of the display screen includes: acquiring parameter information of the M application programs; sequentially acquiring application programs associated with the M application programs according to the parameter information of the M application programs; obtaining through analysis N application programs associated with the application program corresponding to the first application identification in a case that the first application identification is displayed in the first area of the display screen; and acquiring N object identifications of the N application programs and displaying the N object identifications in the second area of the display screen.

Preferably, the displaying N object identifications in the second area of the display screen includes: starting timing once the first application identification occurs in the first area to obtain a timed period; obtaining through analysis N application programs associated with the application program corresponding to the first application identification in a case that the timed period is greater than a preset threshold; and acquiring N object identifications of the N application programs and displaying the N object identifications in the second area of the display screen.

Preferably, the screening, according to the target application program, N application programs which meet a preset association condition from at least one of the application programs except the target application program in the electronic device includes: acquiring preset parameters of the target application program; and finding N application programs matching with the preset parameters of the target application program from at least one of the application programs except the target application program in the electronic device.

Preferably, the displaying N object identifications in the second area of the display screen in a case that a first application identification is displayed in the first area of the display screen includes: sorting N object identifications according to a preset sorting rule; and displaying the sorted N object identifications in the second area of the display screen.

Preferably, the sorting N object identifications according to a preset sorting rule includes: taking times of usage in turn of the application programs corresponding to the object identifications and the first application program corresponding to the first application identification as historical usage records; and sorting the historical usage records corresponding to the N object identifications in order from largest to smallest.

Preferably, the sorting N object identifications according to a preset sorting rule includes: acquiring preset parameters of the first application program corresponding to the first application identification; analyzing matching degrees of parameters of the application programs corresponding to the N object identifications with the preset parameters of the first application program; and sorting the application programs corresponding to the N object identifications according to the matching degrees.

An electronic device is provided, which includes: a display screen; a sensor configured to obtain a first input operation; and a processor connected to the display screen and the sensor, and configured to generate an instruction for calling a task manager according to an obtained first input operation, display M application identifications of M application programs being running in queues on the display screen of the electronic device based on the instruction for calling a task manager, where M is a positive integer greater than or equal to 1, and display N object identifications in the second area of the display screen in a case that a first application identification is displayed in the first area of the display screen. The N object identifications correspond to the N application programs, the N application programs are associated with the first application program corresponding to the first application identification, where N is a positive integer greater than or equal to 1; an application program corresponding to each of the M application identifications is called in response to a first triggering operation, and an application program corresponding to each of the N object identifications is called in response to a second triggering operation.

Preferably, in the electronic device, the N object identifications are sorted according to a preset sorting rule and displayed in the second area of the display screen.

Preferably, in the electronic device, the object identifications are not displayed in the second area of the display screen in a case that the application identifications are not displayed in the first area of the display screen.

From the technical solutions described above, compared with the conventional technology, the disclosure provides a display method. Multiple application identifications of multiple application programs being running are displayed in queues on a display screen of an electronic device based on an instruction for calling a task manager generated via a first input operation. N object identifications are displayed in a second area of the display screen in a case that a first application identification is displayed in a first area of the display screen of the electronic device; the N object identifications correspond to the N application programs, and the N application programs are associated with the first application program corresponding to the first application identification; an application program corresponding to each of the M application identifications is called in response to the first triggering operation, and an application program corresponding to each of the N object identifications is called in response to the second triggering operation. With this method, a number of application programs being currently running in the electronic device may be displayed in a page of the task manager based on the instruction for calling a task manager, and each of the application programs may be associated with multiple application programs, and the application programs associated with an application program being running are directly displayed in a case that the application program being running is selected based on a selection operation in the page of the task manager, which is convenient for a user to directly select an associated application program for operation, with a simple operation process, thereby improving a user's experience.

### BRIEF DESCRIPTION OF THE DRAWINGS

In order to more clearly illustrate technical solutions according to embodiments of the present disclosure or the conventional technology, the drawings to be used in the description of the embodiments or the conventional technology are described briefly as follows. It is apparent that the drawings referred in the following description only illustrate some embodiments of the present disclosure. For those skilled in the art, other drawings may be obtained according to these drawings without any creative work.

FIG. 1 is a schematic diagram of the display of icons for application programs in an electronic device;

FIG. 2 is a flow chart of a display method according to a first embodiment of the disclosure;

FIG. 3 is a schematic diagram of a display content on a display screen in the display method according to the first embodiment of the disclosure;

FIG. 4 is a flow chart of a display method according to a second embodiment of the disclosure;

FIG. 5 is a schematic diagram of a prompt page in the display method according to the second embodiment of the disclosure;

FIG. 6 is a flow chart of a display method according to a third embodiment of the disclosure;

FIG. 7 is a schematic diagram of a prompt page in the display method according to the third embodiment of the disclosure;

FIG. 8 is a flow chart of a display method according to a fourth embodiment of the disclosure;

FIG. 9 is a schematic diagram of a prompt page in the display method according to the fourth embodiment of the disclosure;

FIG. 10 is a flow chart of a display method according to a fifth embodiment of the disclosure;

FIG. 11 is a flow chart of a display method according to a sixth embodiment of the disclosure;

FIG. 12 is a schematic diagram of a display content on a display screen in the display method according to the sixth embodiment of the disclosure;

FIG. 13 is a schematic diagram of another display content on the display screen in the display method according to the sixth embodiment of the disclosure;

FIG. 14 is a flow chart of a display method according to a seventh embodiment of the disclosure;

FIG. 15 is a flow chart of a display method according to an eighth embodiment of the disclosure;

FIG. 16 is a flow chart of a display method according to a ninth embodiment of the disclosure; and

FIG. 17 is a schematic structural diagram of an electronic device according to an embodiment of the disclosure.

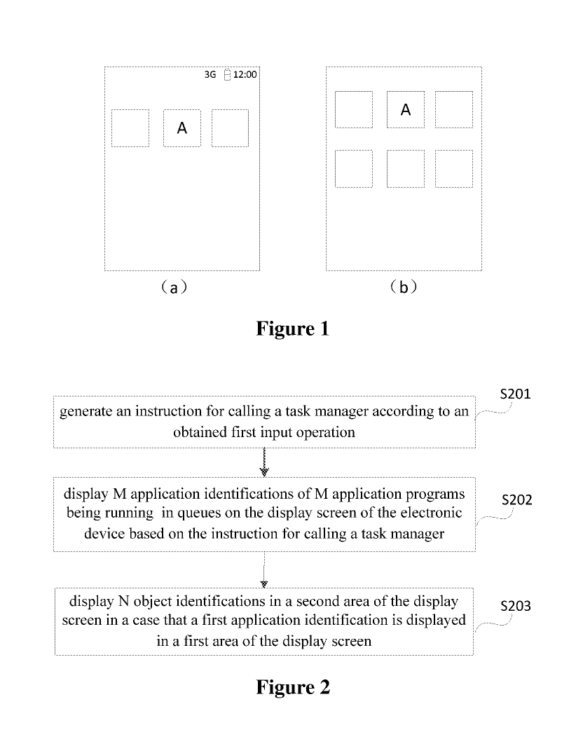

### DETAILED DESCRIPTION

Technical solutions according to embodiments of the disclosure are described clearly and completely in conjunction with the drawings hereinafter. It is apparent that the described embodiments are only a few rather than all of the embodiments of the disclosure. All other embodiments obtained by those skilled in the art based on the embodiments of the disclosure without any creative work fall into the protective scope of the disclosure.

Reference is made to FIG. 2, which is a flow chart of a display method according to a first embodiment of the disclosure. The display method is applied to an electronic device, and the electronic device may be, for example, a desktop computer, a notebook computer, a tablet computer, a mobile phone, a smart television, a smart watch and a wearable device. Multiple application programs are installed in the electronic device.

The display method may include steps S201 to S203.

In step S201, an instruction for calling a task manager is generated according to an obtained first input operation.

A user may call the task manager via a first input operation during the running of an electronic device.

Specifically, the electronic device generates an instruction for calling a task manager according to the obtained first input operation, and then calls the task manager in the electronic device in response to the instruction for calling a task manager.

It should be noted that, the first input operation may be inputted according to the settings of different electronic devices, such as long press of Home key, double clicking of Home key, and a combination of key operations in a mobile phone, and the form of the first input operation is not limited in the disclosure.

In step S202, M application identifications of M application programs being running are displayed in queues on the display screen of the electronic device based on the instruction for calling a task manager, where M is a positive integer greater than or equal to 1.

During the running of the electronic device, there are multiple application programs being running, the application programs being running in the electronic device may be determined based on the instruction for calling a task manager, and the determined M application programs being running in the electronic device may be application programs running in the foreground or may be application programs running in the background.

In a specific embodiment, an application identification of an application program represents the application program. The application identification may be an icon for the application program, or a task image, even a thumbnail of the application program. The form of the application identification is not limited in the disclosure.

The M application identifications may be displayed on the display screen of the electronic device in one screen, or may be displayed in several screens according to the size of the identifications. In a specific embodiment, the number of the application identifications displayed in each screen may be set in accordance with the actual situation, which is not limited in this embodiment.

In step S203, N object identifications are displayed in a second area of the display screen in a case that the first application identification is displayed in a first area of the display screen.

The N object identifications correspond to N application programs, the N application programs are associated with the first application program corresponding to the first application identification, where N is a positive integer greater than or equal to 1.

An application program corresponding to each of the M application identifications is called in response to a first triggering operation; and an application program corresponding to each of the N object identifications is called in response to a second triggering operation.

The display screen includes a first area and a second area. The first area is for displaying an application identification; in a case that the application identification is in the first area, it indicates that the application program corresponding to the application identification is selected. The second area is for displaying a number of object identifications, the application programs corresponding to the object identifications are associated with the application program corresponding to the application identification in the first area.

It should be noted that, the association relationships between the application program corresponding to the first application identification and the associated application programs corresponding to the N object identifications may be association relationships set in advance by a user, specifically, may be association relationships set by a user depending on own usage habits; or the association relationships may be set automatically by the electronic device, and the process of setting automatically the association relationships is explained in the following embodiments, which is not limited in this embodiment.

The application program corresponding to the application identification is called in response to the first triggering operation. In a case that the application program runs in the background, the calling may switch the application program to be an foreground application program; or in a case that the application program runs in the foreground, the calling may switch the display content on the display screen from the interface of the task manager to the interface of the application program, where M application identifications and N object identifications are displayed in the interface of the task manager.

In a specific embodiment, the first triggering operation and the second triggering operation may be the same operation such as a click operation; alternatively, the first triggering operation and the second triggering operation may be different. The implementation forms of the first triggering operation and the second triggering operation are not limited in this embodiment.

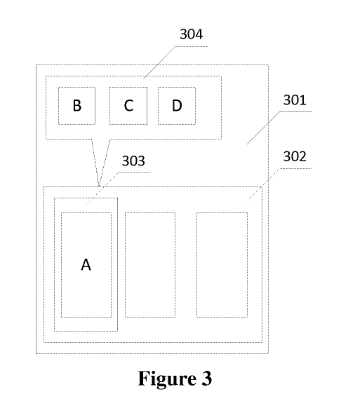

FIG. 3 is a schematic diagram of a display content on a display screen according to this embodiment. The display screen 301 includes an application identification display area 302. The application identification display area 302 includes a first area 303, and an application identification “A” is displayed in the first area 303. The display screen 301 further includes a second area 304, and three object identifications “B”, “C” and “D” are displayed in the second area 304. The application programs corresponding to the object identifications “B”, “C” and “D” are associated with the application program corresponding to the application identification “A”. In a specific embodiment, the application identification “A” may be a “Camera” identification, and the object identifications “B”, “C” and “D” may be, for example, a “WeChat” identification, a “Meituxiuxiu” identification and a “MicroBlog” identification.

In a specific embodiment, in step S203, in a case that the object identifications of N application programs corresponding to the application program of the first application identification are displayed on the display screen, the user may make a selection from the N application programs. The specific process of making a selection includes: obtaining a second triggering operation, where the second triggering operation refers to an operation that an operator selects an object identification corresponding to a target application program in the preset display area; calling the target application program based on the second triggering operation and presenting a display interface of the target application program.

It should be noted that, an object identification is selected based on the second triggering operation; in the case that the application program corresponding to the object identification is disabled, the application program is activated based on the second triggering operation; or in the case that the application program corresponding to the object identification is running, the display interface of the display screen is switched to a display interface of the application program corresponding to the object identification based on the second triggering operation.

In summary, this embodiment provides a display method. Multiple application identifications of multiple application programs being running are displayed in queues on a display screen of an electronic device based on the instruction for calling a task manager generated via a first input operation; N object identifications are displayed in a second area of the display screen in a case that a first application identification is displayed in a first area of the display screen of the electronic device, the N object identifications correspond to N application programs, and the N application programs are associated with the first application program corresponding to the first application identification; an application program corresponding to each of the M application identifications is called in response to the first triggering operation, and an application program corresponding to each of the N object identifications is called in response to the second triggering operation. With this method, a number of application programs being currently running in the electronic device may be displayed in a page of the task manager based on the instruction for calling a task manager; and each of the application programs may be associated with multiple application programs; and the application programs associated with an application program being running are directly displayed in a case that the application program being running is selected based on a selection operation in the page of the task manager, which is convenient for a user to directly select an associated application program for operation, with a simple operation process, thereby improving the user's experience.

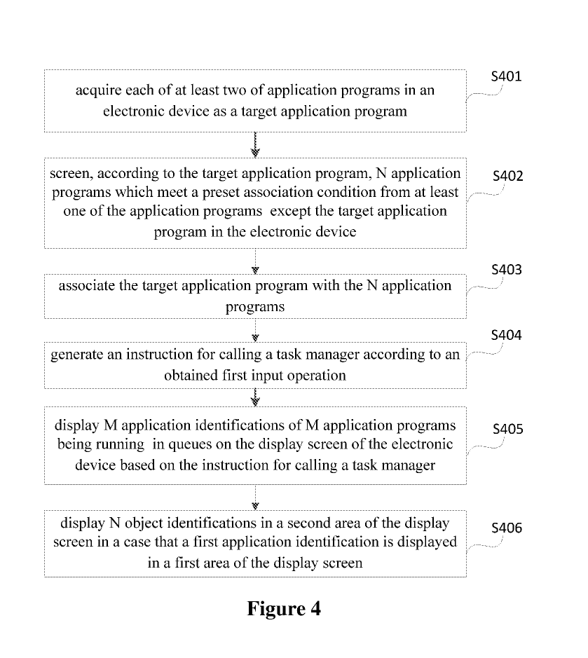

Reference is made to FIG. 4, which is a flow chart of a display method according to a second embodiment of the disclosure. The display method includes steps S401 to S406.

In step S401, each of at least two of the application programs in an electronic device is acquired as a target application program.

Multiple application programs are installed in the electronic device, and each of the application programs may be associated with multiple application programs.

It should be noted that, the association relationships between the application programs may be pre-established before the interface of the task manager is called in the disclosure.

Specifically, each of the application programs in the electronic device is associated with other application programs.

Each of the application programs in the electronic device is sequentially acquired as a target application program, and association relationships between the target application program and other application programs are established based on the target application program in the following steps.

In a specific embodiment, a new application program may be added during the usage of the electronic device, and association relationships between the new application program and other application programs installed in the electronic device may be established once the new application program is installed.

In a specific embodiment, a user may decide on his own whether to establish association relationships between the application programs.

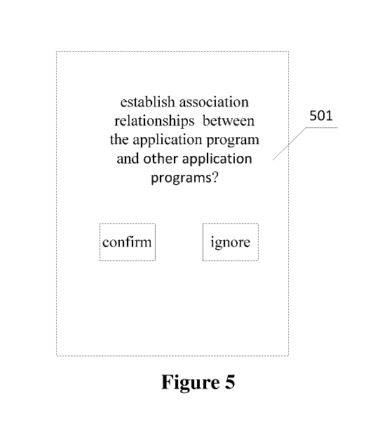

FIG. 5 is a schematic diagram of a prompt page according to this embodiment, and the prompt page is for prompting the user whether to establish association relationships. The prompt page includes a prompt dialog box 501; the prompt dialog box 501 includes a prompt message of “whether to establish association relationships between the application program and other application programs”, and two options “confirm” and “ignore”. In a case that the user selects the option “confirm”, association relationships between the application program and other application programs installed in the electronic device may be established; or in a case that the user selects the option “ignore”, the association relationships are not established. It should be noted that “the application program” may be replaced by a name of each of the application programs installed in the electronic device, such as “Camera”, “WeChat” and “Meituxiuxiu”, and the name of the application program is not limited in this embodiment.

In a specific embodiment, the options may be other texts indicative of determining the establishment of association relationships and denying the establishment of association relationships, such as “yes” and “no”; and the form of the options is not limited in this embodiment.

It should be noted that, in a case that the application program is a new one, that is, the application program is just downloaded, is being installed or will be installed by the user, a step of determining whether to establish association relationships is added after the application program is installed.

In step S402, N application programs which meet a preset association condition are screened from at least one of the application programs except the target application program in the electronic device according to the target application program.

In a case that an application program is determined to be a target application program, application programs associated with the target application program are determined.

In this embodiment, the electronic device automatically select application programs associated with the target application program.

A preset association condition is set for the electronic device; any two of the application programs are associated with each other in the case that the two application programs meet the preset association condition, or they are not associated with each other.

Specifically, N application programs which meet a preset association condition are screened from multiple application programs except the target application program in the electronic device based on the preset association condition, where N is a positive integer greater than or equal to 1.

In a specific embodiment, the step S402 may be implemented by the following steps: acquiring preset parameters of the target application program, and finding N application programs matching with the preset parameters of the target application program from at least one of the application programs except the target application program in the electronic device.

It should be noted that, multiple parameters are set for the application programs, one or more of the multiple parameters are selected to be preset parameters, and it is determined whether the two application programs meet the preset association condition based on the preset parameters. The preset parameters may be category tags of application programs, for example, the tags of the application program “WeChat” may include such as “chat”, “friend circle” and “photo”, and the tags of the application program “Meituxiuxiu” may include such as “photo”, “beautifying” and “image processing”.

It should be noted that, the category tags of each of the application programs may be multiple, and the category tags may be set by a developer of the application programs, or may be defined by a user when downloading an APP package for the application programs; the parameters of the application programs are not limited in this embodiment.

In step S403, the target application program is associated with the N application programs.

Specifically, association relationships between the screened N application programs which meet the preset association condition and the target application program are established.

In a specific embodiment, an association list is established to present the association relationships between the target application program and the N application programs.

Specifically, the association list may be shown in Table 1 below.

TABLE 1

| Target application program | Associated application program |
|---|---|
| Camera | WeChat |
| | . . . |
| | Meituxiuxiu |
| | MicroBlog |
| | Image manager |
| . . . | . . . |
| . . . | . . . |
| WeChat | Firend circle |
| | Camera |

It should be noted that, the application programs in an electronic device are listed in the left-hand column of Table 1, “Camera” and “WeChat” are taken as examples for explanation in this embodiment, and the disclosure is not limited to these two application programs.

In step S404, an instruction for calling a task manager is generated according to an obtained first input operation.

In step S405, M application identifications of M application programs being running are displayed in queues on the display screen of the electronic device based on the instruction for calling a task manager.

In step S406, N object identifications are displayed in the second area of the display screen in a case that a first application identification is displayed in the first area of the display screen.

The steps S404 to S406 are the same as the steps S201 to S203 in the first embodiment, which are not described in detail in this embodiment.

In summary, this embodiment provides a display method. The display method further includes: acquiring each of at least two of the application programs in the electronic device as a target application programs; screening, according to the target application program, N application programs which meet a preset association condition from at least one of the application programs except the target application program in the electronic device; and associating the target application program with the N application programs. With this method, the association relationships between the application programs in the electronic device and the associated application programs are established before the electronic device calls the task manager, therefore, it is ensured that the object identifications of N application programs associated with the application program corresponding to the first application identification displayed in the first area may be directly acquired based on the instruction for calling a task manager, with simple operation.

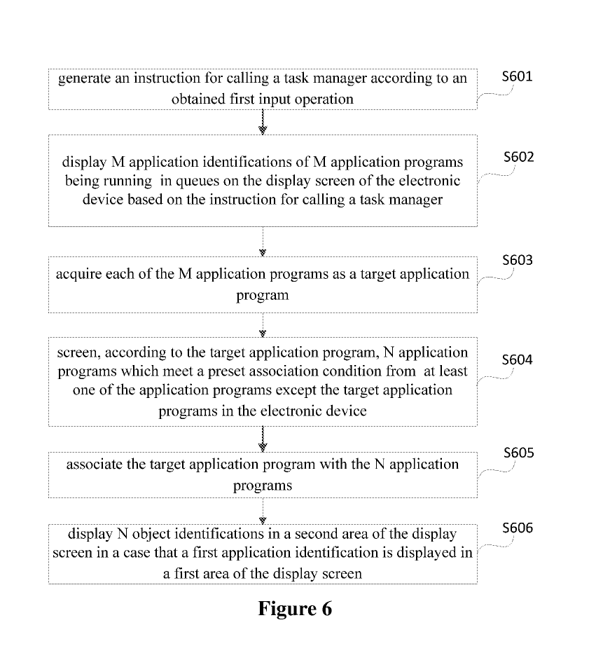

Reference is made to FIG. 6, which is a flow chart of a display method according to a third embodiment of the disclosure. The method includes steps S601 to S606.

In step S601, an instruction for calling a task manager is generated according to an obtained first input operation.

In step S602, M application identifications of M application programs being running are displayed in queues on the display screen of the electronic device based on the instruction for calling a task manager.

The steps S601 to S602 are the same as the steps S201 to S202 in the first embodiment, which are not described in detail in this embodiment.

In step S603, each of the M application programs is acquired as a target application program.

The electronic device may determine based on the instruction for calling a task manager that there are M application programs being running; and each of the M application programs may be associated with multiple application programs, the application programs associated with each of the M application programs are determined.

It should be noted that, the association relationships may be immediately established for the application programs being running at the beginning of calling the interface of the task manager in the disclosure.

Specifically, application programs are associated for each of the M application programs.

Each of the M application programs is sequentially acquired as a target application program, and association relationships between the target application program and other application programs are established based on the target application program in the following steps.

In a specific embodiment, a user may decide on his own whether to set association relationships in a case that the interface of the task manager is entered based on the instruction for calling a task manager.

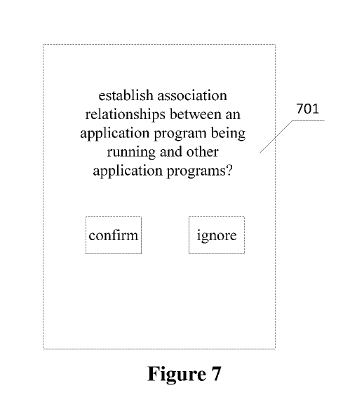

FIG. 7 is a schematic diagram of a prompt page according to this embodiment; and the prompt page is for prompting the user whether to establish association relationships. The prompt page includes a prompt dialog box 701; the prompt dialog box 701 includes a prompt message of “whether to establish association relationships between an application program being running and other application programs”, and two options “confirm” and “ignore”. In a case that the user selects the option “confirm”, association relationships between the application program being running and other application programs installed in the electronic device are established; or in a case that the user selects the option “ignore”, the association relationships are not established.

In a specific embodiment, the options may be other texts indicative of determining the establishment of association relationships and denying the establishment of association relationships, such as “yes” and “no”; and the form of the options is not limited in this embodiment.

In step S604, N application programs which meet a preset association condition are screened from at least one of the application programs except the target application program in the electronic device according to the target application program.

In a case that an application program is determined to be a target application program, application programs associated with the target application program are determined.

In this embodiment, the electronic device automatically select application programs associated with the target application program.

A preset association condition is set for the electronic device, any two of the application programs are associated with each other in the case that the two application programs meet the preset association condition, or they are not associated with each other.

Specifically, N application programs which meet a preset association condition are screened from multiple application programs except the target application program in the electronic device based on the preset association condition, where N is a positive integer greater than or equal to 1.

In a specific embodiment, the step S604 may be implemented by the following steps: acquiring preset parameters of the target application program, and finding N application programs matching with the preset parameters of the target application program from at least one of the application programs except the target application program in the electronic device.

It should be noted that, multiple parameters are set for the application programs, one or more of the multiple parameters are selected to be preset parameters, and it is determined whether the two application programs meet the preset association condition based on the preset parameters. The preset parameters may be category tags of the application programs, for example, the tags of the application program “WeChat” may include such as “chat”, “friend circle” and “photo”, and the tags of the application program “Meituxiuxiu” may include such as “photo”, “beautifying” and “image processing”.

It should be noted that, the category tags of each of the application programs may be multiple, and the category tags may be set by a developer of the application programs, or may be defined by a user when downloading an APP package for the application programs; the parameters of the application programs are not limited in this embodiment.

In step S605, the target application program is associated with the N application programs.

Specifically, association relationships between the screened N application programs which meet the preset association condition and the target application program are established.

In a specific embodiment, an association list is established to present the association relationships between the target application program and the N application programs.

Specifically, the association list may be shown in Table 2 below.

TABLE 2

| Target application program | Associated application program |
|---|---|
| Camera | WeChat |
| | . . . |
| | Meituxiuxiu |
| | MicroBlog |
| | Image manager |
| . . . | . . . |
| WeChat | Friend circle |
| | Camera |

It should be noted that, the application programs corresponding to the M application identification on the display screen are listed in the left-hand target application program column of Table 2, the four application programs are taken as target application programs if there are four application programs being running in the electronic device, the application programs associated with the target application programs are listed respectively in the right-hand associated application program column. “Camera” and “WeChat” are taken as examples for explanation in this embodiment, and the disclosure is not limited to these two application programs.

In step S606, N object identifications are displayed in the second area of the display screen in a case that the first application identification is displayed in the first area of the display screen.

The step S606 is the same as the step S203 in the first embodiment, which is not described in detail in this embodiment.

In summary, this embodiment provides a display method. The display method further includes: acquiring each of the M application programs as a target application programs; screening, according to the target application program, N application programs which meet a preset association condition from at least one of the application programs except the target application program in the electronic device; and associating the target application program with the N application programs. With this method, the association relationships between the application programs being running in the electronic device and the associated application programs are established before the electronic device calls the task manager, therefore, it is ensured that the object identifications of N application programs associated with the application program corresponding to the first application identification displayed in the first area may be directly acquired based on the running application program, with simple operation.

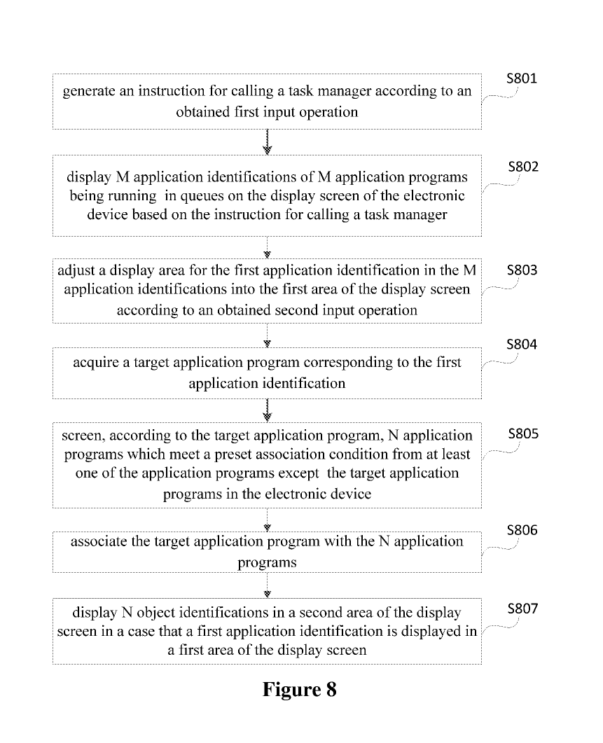

Reference is made to FIG. 8, which is a flow chart of a display method according to a fourth embodiment of the disclosure. The method includes steps S801 to S807.

In step S801, an instruction for calling a task manager is generated according to an obtained first input operation.

In step S802, M application identifications of M application programs being running are displayed in queues on the display screen of the electronic device based on the instruction for calling a task manager.

The steps S801 to S802 are the same as the steps S201 to S202 in the first embodiment, which are not described in detail in this embodiment.

In step S803, a display area for the first application identification in the M application identifications is adjusted into the first area of the display screen according to an obtained second input operation.

In a specific embodiment, a user may input a second input operation to adjust the display area of M application identifications on the display screen of the electronic device. The display area of the first application identification in the M application identifications may be adjusted into the first area based on the second input operation.

For example, the user may perform an input operation by sliding up and down or left and right in the case that the electronic device is a touch screen; the user's finger may slide left and right on the display screen to adjust the display area of each of the application identifications is adjusted, in the case that the M application identifications are arranged laterally; or the user's finger may slide up and down on the display screen to adjust the display area of each of the application identifications is adjusted, in the case that the M application identifications are arranged longitudinally.

The electronic device may determine that there are M application programs being running based on the instruction for calling a task manager, and each of the M application programs may be associated with multiple application programs. In order to reduce the amount of data processing for retrieving the application programs associated with the M application programs, only an application program in the first area may be selected as a target application program, and the associated application programs are associated with the target application program.

Specifically, an application identification (i.e., the first application identification) in the M application identifications is adjusted into the first area for displaying based on the second input operation inputted by the user.

It should be noted that, in a case that the user inputs the first input operation based on an interface of an application program, the user may enter a task manager based on the application program, and the identification of the application program is in the first area of the interface of the task manager by default.

In step S804, a target application program corresponding to the first application identification is acquired.

Based on the step S803, the first application identification is determined to be in the first area, and the application program corresponding to the first application identification is a target application program.

The acquired application program corresponding to the first application identification is a target application program.

In a specific embodiment, the user may select a first application identification and decide on his own whether to set association relationships in a case that the interface of the task manager is entered based on the instruction for calling a task manager.

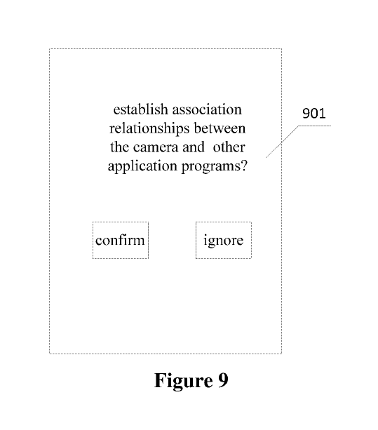

FIG. 9 is a schematic diagram of a prompt page according to this embodiment; and the prompt page is for prompting the user whether to establish association relationships. The prompt page includes a prompt dialog box 901. For example, in a case that the selected application program is a camera in this embodiment, the prompt dialog box 901 includes a prompt message of “whether to establish association relationships between the camera and other application programs”, and two options “confirm” and “ignore”; and in a case that the user selects the option “confirm”, association relationships between the selected application program and other application programs installed in the electronic device may be established; in a case that the user selects the option “ignore”, the association relationships are not established.

In a specific embodiment, the options also may be other texts indicative of determining the establishment of association relationships and denying the establishment of association relationships, such as “yes” and “no”; and the form of the options is not limited in this embodiment.

In step S805, N application programs which meet a preset association condition are screened from at least one of the application programs except the target application program in the electronic device according to the target application program.

In a case that the application program corresponding to the first application identification is determined to be a target application program, application programs associated with the target application program are determined.

In this embodiment, the electronic device automatically select application programs associated with the target application program.

A preset association condition is set for the electronic device; any two of the application programs are associated with each other in the case that the two application programs meet the preset association condition, or they are not associated with each other.

Specifically, N application programs which meet a preset association condition are screened from multiple application programs except the target application program in the electronic device based on the preset association condition, where N is a positive integer greater than or equal to 1.

In a specific embodiment, the step S805 may be implemented by the following steps: acquiring preset parameters of the target application program, and finding N application programs matching with the preset parameters of the target application program from at least one of the application programs except the target application program in the electronic device.

It should be noted that, multiple parameters are set for the application programs, one or more of the multiple parameters are selected to be preset parameters, and it is determined whether the two application programs meet the preset association condition based on the preset parameters. The preset parameters may be category tags of application programs, for example, the tags of the application program “WeChat” may include such as “chat”, “friend circle” and “photo”, and the tags of the application program “Meituxiuxiu” may include such as “photo”, “beautifying” and “image processing”.

It should be noted that, the category tags of each of the application programs may be multiple, and the category tags may be set by a developer of the application programs, or may be defined by a user when downloading an APP package for the application programs; the parameters of the application programs are not limited in this embodiment.

In step S806, the target application program is associated with the N application programs.

Specifically, association relationships between the screened N application programs which meet the preset association condition and the target application program are established.

In a specific embodiment, an association list is established to present the association relationships between the target application program and the N application programs.

Specifically, the association list may be shown in Table 3 below.

TABLE 3

| Target application program | Associated application program |
|---|---|
| Camera | WeChat |
| | . . . |
| | Meituxiuxiu |
| | MicroBlog |
| | Image manager |

It should be noted that, the application programs (such as “Camera”) corresponding to the first application identification on the display screen are listed in the left-hand target application program column of Table 3, and the associated application programs corresponding to the target application program are listed in the right-hand associated application program column.

In step S807, N object identifications are displayed in the second area of the display screen in a case that a first application identification is displayed in the first area of the display screen.

The step S807 is the same as the step S203 in the first embodiment, which is not described in detail in this embodiment.

In summary, this embodiment provides a display method. The display method further includes: adjusting a display area for the first application identification in the M application identifications into the first area of the display screen according to an obtained second input operation; acquiring a target application program corresponding to the first application identification; screening, according to the target application program, N application programs which meet a preset association condition from at least one of the application programs except the target application program in the electronic device; and associating the target application program with the N application programs. With this method, the association relationships between the application program corresponding to the selected application identification in the first area of the electronic device and the associated application programs are established before the electronic device calls a task manager, therefore, it is ensured that the object identifications of N application programs associated with the application program corresponding to the first application identification displayed in the first area may be directly acquired based on the running application program, with simple operation.

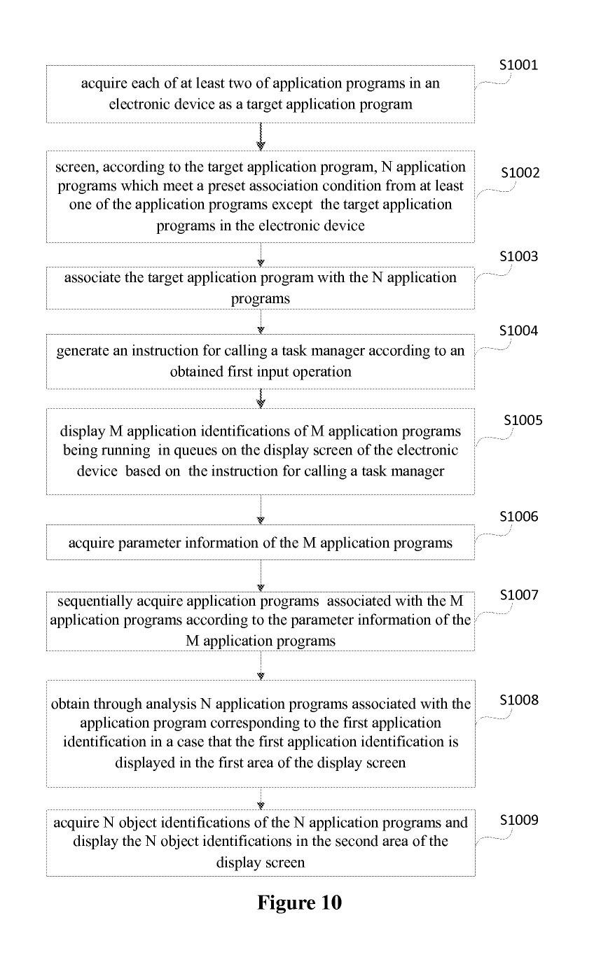

Reference is made to FIG. 10, which is a flow chart of a display method according to a fifth embodiment of the disclosure. The method includes steps S1001 to S1009.

In step S1001, each of at least two of the application programs in an electronic device are acquired as a target application program.

In step S1002, N application programs which meet a preset association condition are screened from at least one of the application programs except the target application program in the electronic device according to the target application program.

In step S1003, the target application program is associated with the N application programs.

In step S1004, an instruction for calling a task manager is generated according to an obtained first input operation.

In step S1005, M application identifications of M application programs being running are displayed in queues on the display screen of the electronic device based on the instruction for calling a task manager.

The steps S1001 to S1005 are the same as the steps S301 to S305 in the second embodiment, which are not described in detail in this embodiment.

In step S1006, parameter information of the M application programs is acquired.

The parameter information of the M application programs is acquired after the M application programs being running are determined based on the instruction for calling a task manager.

It should be noted that, the parameter information indicates the uniqueness of the application program, for example, the parameter information may be a name of the application program or other remarkable information.

In step S1007, application programs associated with the M application programs are acquired sequentially according to the parameter information of the M application programs.

Based on the parameter information of each of the M application programs being running, the associated application programs are acquired.

Specifically, the association relationships between all the application programs in the electronic device may be found in the list of Table 1 based on the parameter information of the application program.

For example, in the case that the parameter information of the application program is the name “Camera” of the application program, application programs associated with the application program “Camera” may be found in the list of Table 1, such as “WeChat”, . . . , “Meituxiuxiu”, “MicroBlog” and “Image manager”. Application programs associated with each of the application programs being running are found in turn, to acquire the associated application programs.

In step S1008, N application programs associated with the application program corresponding to a first application identification are acquired through analysis in a case that the first application identification is displayed in the first area of the display screen.

The N application programs associated with the application program corresponding to the first application identification are selected based on the first application identification in a case that the first application identification is displayed in the first area of the display screen.

For example, in the case that the application program corresponding to the first identification is “Camera”, the application programs such as “WeChat”, . . . , “Meituxiuxiu”, “MicroBlog” and “Image manager” associated with the application program “Camera” may be acquired based on the application programs associated with the M application programs acquired in the step S1007.

In step S1009, N object identifications of the N application programs are acquired and displayed in the second area of the display screen.

Specifically, N object identifications are acquired correspondingly based on the acquired N application programs, and the N object identifications are displayed in the second area of the display screen.

In summary, this embodiment provides a display method, the displaying N object identifications in the second area of the display screen includes: acquiring parameter information of the M application programs; sequentially acquiring application programs associated with the M application programs according to the parameter information of the M application programs; and obtaining through analysis N application programs associated with the application program corresponding to the first application identification in a case that the first application identification is displayed in the first area of the display screen; and acquiring N object identifications of the N application programs and displaying the N object identifications in the second area of the display screen. With this method, the application programs associated with M application programs are acquired after the M application programs being running are determined in the electronic device, and N application programs associated with the application program corresponding to the first application identification are selected from the application programs associated with the M application programs after the application program corresponding to the first application identification displayed in the first area of the display screen is determined. Therefore, it is ensured that the object identifications of N application programs associated with the application program corresponding to the first application identification displayed in the first area may be directly acquired based on the instruction for calling a task manager, with simple operation.

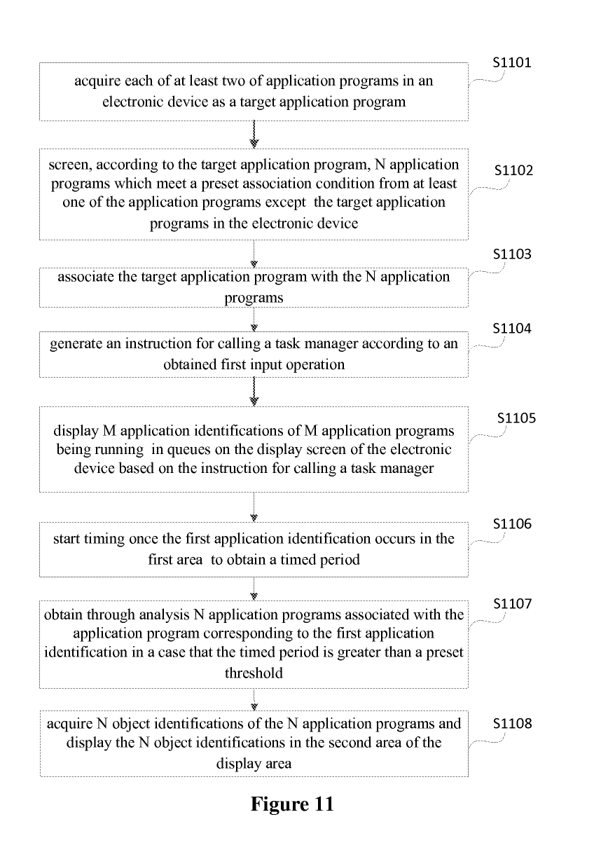

Reference is made to FIG. 11, which is a flow chart of a display method according to a sixth embodiment of the disclosure. The method includes steps S1101 to S1108.

In step S1101, each of at least two of the application programs in an electronic device is acquired as a target application program.

In step S1102, N application programs which meet a preset association condition are screened from at least one of the application programs except the target application program in the electronic device according to the target application program.

In step S1103, the target application program is associated with the N application programs.

In step S1104, an instruction for calling a task manager is generated according to an obtained first input operation.

In step S1105, M application identifications of M application programs being running are displayed in queues on the display screen of the electronic device based on the instruction for calling a task manager.

The steps S1101 to S1105 are the same as the steps S301 to S305 in the second embodiment, which is not described in detail in this embodiment.

In step S1106, timing is started once the first application identification occurs in the first area to obtain a timed period.

In a specific embodiment, the locations of the application identifications of the M application programs displayed on the display screen of the electronic device may be adjusted based on an operation of the user, and each of the application identifications may randomly occur in the first area.

It may be determined, based on the timed period, whether an application identification occurring in the first area is the application identification selected by the user.

Specifically, timing is started once the first application identification occurs in the first area to obtain a timed period. During the timed period, only the first application identification is displayed in the interface of the task manager displayed on the display screen, but the second area is not displayed.

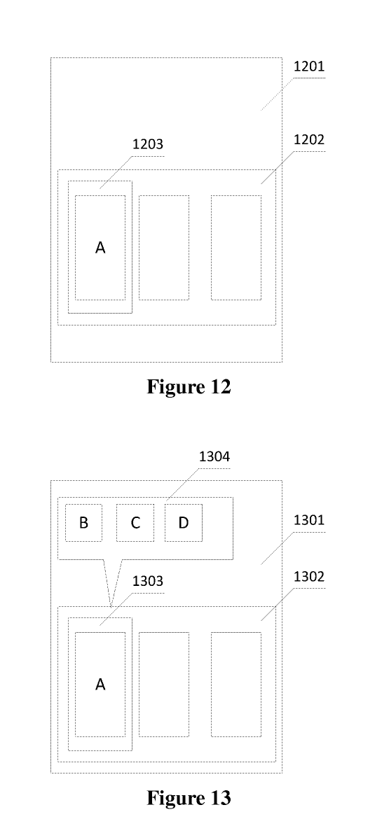

FIG. 12 is a schematic diagram of a display content on a display screen in this embodiment, which shows a moment when the first application identification “A” occurs in the first area. The display screen 1201 includes an application identification display area 1202, and the application identification display area 1202 includes a first area 1203 in which the first application identification “A” is displayed.

In step S1107, N application programs associated with the application program corresponding to the first application identification are obtained through analysis in a case that the timed period is greater than a preset threshold.

The relationship between the timed period and the preset threshold is judged in a real-time manner, and it may be determined that the first application identification is selected by the user in a case that the timed period is greater than the preset threshold.

In this case, N application programs associated with the application program corresponding to the first application identification are selected through analysis based on the selected first application identification.

For example, in the case that the application program corresponding to the first identification is “camera”, the application programs such as “WeChat”, . . . , “Meituxiuxiu”, “MicroBlog” and “Image manager” associated with the application program “camera” may be acquired based on the application programs and the associated application programs in the step S1103.

In step S1108, N object identifications of the N application programs are acquired and displayed in the second area of the display area.

Specifically, the N object identifications are acquired correspondingly based on the determined N application programs and displayed in the second area of the display screen.

FIG. 13 is a schematic diagram of another display content on a display screen according to this embodiment, which shows a moment when the first application identification “A” is determined to be the selected target application identification. The display screen 1301 includes an application identification display area 1302, and the application identification display area 1302 includes a first area 1303 in which the application identification “A” is displayed. The display screen further includes a second area 1304, three object identifications “B”, “C” and “D” are displayed in the second area 1304, and the application programs corresponding to the three object identifications “B”, “C” and “D” are associated with the application program corresponding to the application identification “A”. In a specific embodiment, the application identification “A” may be a “camera” identification, and the object identifications “B”, “C” and “D” may be, for example, a “WeChat” identification, a “Meituxiuxiu” identification and a “MicroBlog” identification.

In summary, this embodiment provides a display method, the displaying N object identifications in the second area of the display screen includes: starting timing once the first application identification occurs in the first area to obtain a timed period; obtaining through analysis N application programs associated with the application program corresponding to the first application identification in a case that the timed period is greater than a preset threshold; and acquiring N object identifications of the N application programs and displaying the N object identifications in the second area of the display screen. With this method, after the first application identification in the first area is determined to the application identification selected by the user, N application identifications associated with the application program corresponding to the application identification are acquired and limited in the second area, thereby eliminating a step of determining the associated application programs of the application program occurring randomly in the first area, and reducing the amount of data processing of the electronic device.

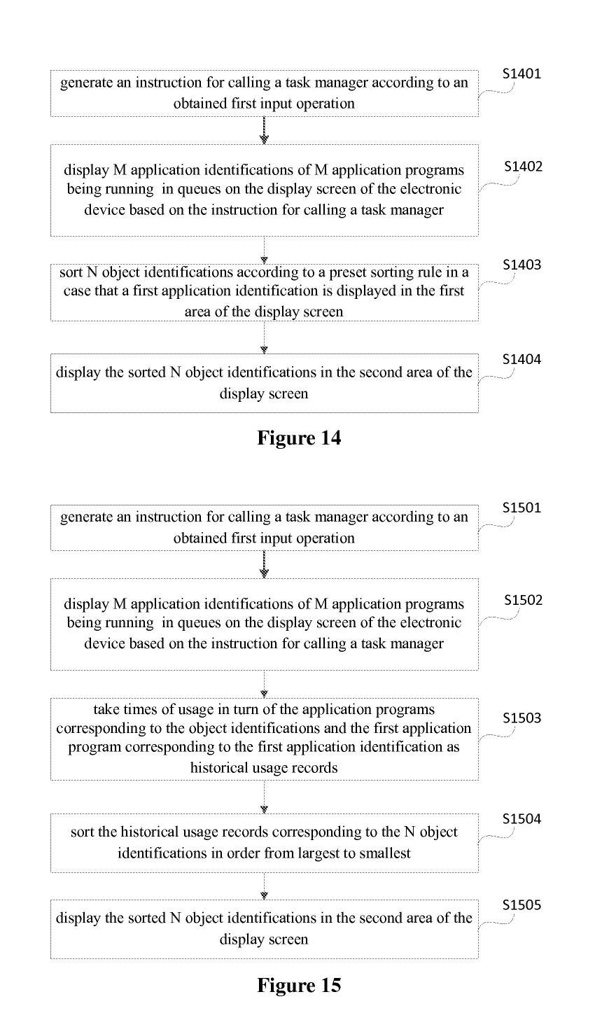

Reference is made to FIG. 14, which is a flow chart of a display method according to a seventh embodiment of the disclosure. The method includes steps S1401 to S1404.

In step S1401, an instruction for calling a task manager is generated according to an obtained first input operation.

In step S1402, M application identifications of M application programs being running are displayed in queues on the display screen of the electronic device based on the instruction for calling a task manager.

The steps S1401 to S1402 are the same as the steps S201 to S202 in the first embodiment, which is not described in detail in this embodiment.

In step S1403, N object identifications are sorted according to a preset sorting rule in a case that a first application identification is displayed in the first area of the display screen.

In a case that the first application identification is displayed in the first area of the display screen, the associated N application programs are determined based on the application program corresponding to the first application identification, the object identifications corresponding to the N application programs are sorted based on the preset sorting rule.

It should be noted that, the way of sorting is described in detail in the following embodiments, which is not described in detail in this embodiment.

In step S1404, the sorted N object identifications are displayed in the second area of the display screen.

After the N object identifications are sorted, the sorted N object identifications are displayed in the second area of the display screen according to the sorting order, for user selection in the second area based on the requirements.

In summary, this embodiment provides a display method, the displaying N object identifications in a second area of the display screen in a case that a first application identification is displayed in a first area of the display screen includes: sorting the N object identifications according to a preset sorting rule, and displaying the sorted N object identifications in the second area of the display screen. With this method, the object identifications of the N application programs associated with the application program corresponding to the first application identification are sorted based on the preset sorting rule, which is convenient for a user to select an associated application program based on their own requirements, thereby improving the user's experience.

Reference is made to FIG. 15, which is a flow chart of a display method according to an eighth embodiment of the disclosure. The method includes steps S1501 to S1505.

In step S1501, an instruction for calling a task manager is generated according to an obtained first input operation.

In step S1502, M application identifications of M application programs being running are displayed in queues on the display screen of the electronic device based on the instruction for calling a task manager.

The steps S1501 to S1502 are the same as the steps S1401 to S1402 in the seventh embodiment, which are not described in detail in this embodiment.

In step S1503, times of usage in turn of the application programs corresponding to the object identifications and the first application program corresponding to the first application identification are taken as historical usage records.

It should be noted that, in a case that the user uses the application programs installed in an electronic device, any two of the application programs may be used in turn depending on own usage habits. For example, after the user opens a “Taobao” application program, the user may immediately open a “price comparison” application program to determine the price of an item in “Taobao” and the price of the item in other websites; as another example, after the user opens a “Camera” application program, the user may generally open “Meituxiuxiu” to process the image taken by “Camera”. Based on the historical usage records of the user, it may be determined which application program the user may prefer to use after using an application program.

Therefore, times of usage in turn of the associated application programs corresponding to the object identifications and the first application program corresponding to the first application identification are taken as historical usage records in this embodiment, and the historical usage records indicate times, frequency and time of usage in turn of the first application program and the associated application programs.

In step S1504, the historical usage records corresponding to the N object identifications are sorted in order from largest to smallest.

The historical usage records include information such as times and frequency, the association degrees between the application programs corresponding to the object identifications and the application program corresponding to the first application identification is determined based on the parameters such as times, frequency and time; for example, the greater the times is, the greater the association degree is; the higher the frequency is, the higher the association degree is; and the closer the time is, the higher the association degree is.

In a specific embodiment, weight values may be set for the parameters such as times, frequency and time in accordance with the actual situation, association degrees are calculated based on the parameters and the weight values thereof, and the application programs are sorted based on the calculated association degrees.

Generally, the sorting is performed in order from largest to smallest, the object identification with the greatest association degree is at the top of the list, and the object identification with the smallest association degree is at the bottom of the list.

In step S1505, the sorted N object identifications are displayed in the second area of the display screen.

The step S1505 is the same as the step S1404 in the seventh embodiment, which is not described in detail in this embodiment.

In summary, this embodiment provides a display method, the sorting the N object identifications according to a preset sorting rule includes: taking times of usage in turn of the application programs corresponding to the object identifications and the first application program corresponding to the first application identification as historical usage records; and sorting the historical usage records corresponding to the N object identifications in order from largest to smallest. With this method, the object identifications of application programs associated with the first application program corresponding to the first application identification are sorted based on the historical usage of a user, which is more close to the user's usage habits, thereby improving the user's experience.

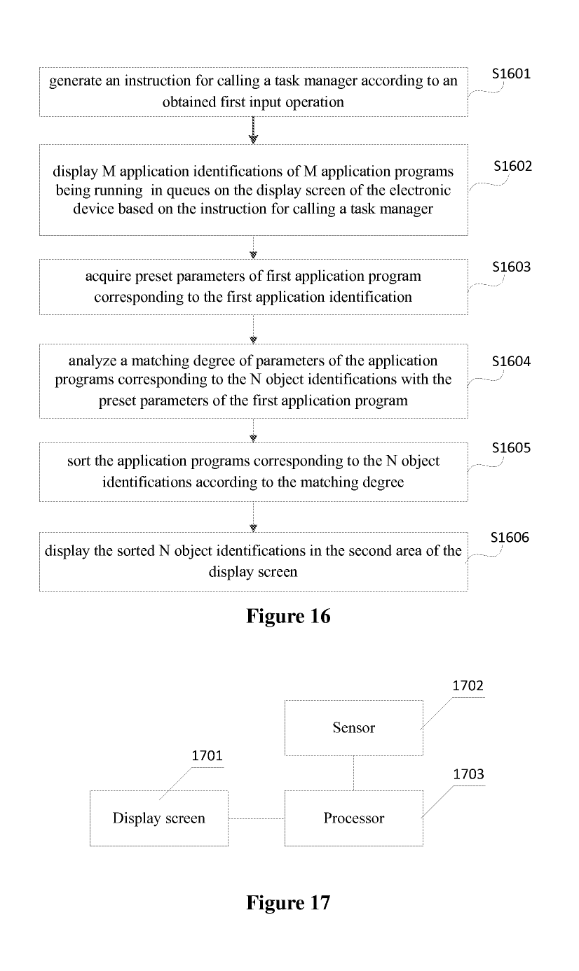

Reference is made to FIG. 16, which is a flow chart of a display method according to a ninth embodiment of the disclosure. The method includes steps S1601 to S1606.

In step S1601, an instruction for calling a task manager is generated according to an obtained first input operation.

In step S1602, M application identifications of M application programs being running are displayed in queues on the display screen of the electronic device based on the instruction for calling a task manager.

The steps S1601 to S1602 are the same as the steps S1401 to S1402 in the seventh embodiment, which are not described in detail in this embodiment.

In step S1603, preset parameters of first application program corresponding to the first application identification are acquired.

It should be noted that, multiple parameters are set for each of application programs, one or more of the multiple parameters are selected to be preset parameters, and it is determined whether the two application programs meet the preset association condition based on the preset parameters. The preset parameters may be category tags of application programs.

The acquired preset parameters of the first application program corresponding to the first application identification may be all list tags of the application programs.

In step S1604, matching degrees of the parameters of the application programs corresponding to the N object identifications with the preset parameters of the first application program are analyzed.

The parameters of the application programs corresponding to the N object identifications are acquired, and the parameters are all category tags of the application programs.

Specifically, the parameters of the application programs corresponding to the N object identifications are compared with the preset parameters of the first application program to determine the matching degrees between them.

Specifically, the parameters of the application programs corresponding to the N object identifications are compared in turn with the preset parameters of the first application program to determine the matching degrees between them.

The larger the number of the parameters of the application programs corresponding to the object identifications being the same as the preset parameters of the first application program, the greater the matching degrees between them is.

In step S1605, the application programs corresponding to the N object identifications are sorted according to the matching degrees.

According to the matching degrees of the N application programs corresponding to the N object identifications with the first application program, the N application programs are sorted, that is, the N object identifications are sorted.

It should be noted that, the greater the matching degrees between the parameters of the two application programs are, the greater the matching value is.

Generally, the sorting is performed in order from largest to smallest, the object identification with the greatest association degree is at the top of the list, and the object identification with the smallest association degree is at the bottom of the list.

In step S1606, the sorted N object identifications are displayed in the second area of the display screen.

The step S1606 is the same as the step S1404 in the seventh embodiment, which is not described in detail in this embodiment.

In summary, this embodiment provides a display method. The sorting the N object identifications according to a preset sorting rule includes: acquiring preset parameters of the first application program corresponding to the first application identification, analyzing a matching degrees of the parameters of the application programs corresponding to the N object identifications with the preset parameters of the first application program, and sorting the application programs corresponding to the N object identifications according to the matching degrees. With this method, the object identifications of the application programs associated with the first application program corresponding to the first application identification are sorted based on the matching degrees between the first application program and the associated application programs, which increments the content of the application programs themselves, and is convenient for a user to select a similar application program for operation, thereby improving the user's experience.

A display method is described in detail according to the above embodiments of the disclosure, and the display method may be implemented by various devices, therefore, an electronic device to which the display method is applied is further provided, which is described in detail according to the following embodiments.

Reference is made to FIG. 17, which is a schematic structural diagram of an electronic device according to an embodiment of the disclosure. The electronic device may be, for example, a desktop computer, a notebook computer, a tablet computer, a mobile phone, a smart television, a smart watch and a wearable device. Multiple application programs are installed in the electronic device.

The electronic device may include a display screen 1701, a sensor 1702, and a processor 1703.

The sensor 1702 is configured to obtain a first input operation.

The processor 1703 is connected with the display screen 1701 and the sensor 1702 and configured to: generate an instruction for calling a task manager according to the obtained first input operation; display M application identifications of M application programs being running in queues on the display screen of the electronic device based on the instruction for calling a task manager, where M is a positive integer greater than or equal to 1; displaying N object identifications in a second area of the display screen in a case that a first application identification is displayed in a first area of the display screen; the N object identifications correspond to the N application programs, the N application programs are associated with the first application program corresponding to the first application identification, where N is a positive integer greater than or equal to 1; an application program corresponding to each of the M application identifications is called in response to a first triggering operation, and an application program corresponding to each of the N object identifications is called in response to a second triggering operation.

The N object identifications are displayed according to the preset sorting rule in the second area of the display screen.

The display content of the display screen makes reference to FIGS. 3 and 13, which is not described in detail in this embodiment.

In a case that the application identification is not displayed in the first area of the display screen, the object identifications are not displayed in the second area of the display screen.

Specifically, the display content of the display screen makes reference to FIG. 12, which is not described in detail in this embodiment.

In a specific embodiment, the processor may include an instruction generation module, a first display module, and a second display module.

The instruction generation module is configured to generate an instruction for calling a task manager according to an obtained first input operation.

The first display module is configured to display M application identifications of M application programs being running in queues on the display screen of the electronic device based on the instruction for calling a task manager.

The second display module is configured to display N object identifications in the second area of the display screen in a case that a first application identification is displayed in the first area of the display screen.

Preferably, the processor further includes an association establishing module. The association establishing module is configured to: acquire each of at least two of the application programs in the electronic device as a target application program; screen, according to the target application program, N application programs which meet a preset association condition from at least one of the application programs except the target application program in the electronic device; and associate the target application program with the N application programs.

Preferably, the first display module includes an association establishing unit. The association establishing unit is configured to: acquire each of the M application programs as a target application program; screen, according to the target application program, N application programs which meet a preset association condition from at least one of the application programs except the target application program in the electronic device; and associate the target application program with the N application programs.

Preferably, the first display module includes an association establishing unit. The association establishing unit is configured to: adjust a display area for the first application identification in the M application identifications into the first area of the display screen according to an obtained second input operation; acquire the target application program corresponding to the first application identification; screen, according to the target application program, N application programs which meet a preset association condition from at least one of the application programs except the target application program in the electronic device; and associate the target application program with the N application programs.

Preferably, the second display module includes an acquiring unit, a first analyzing unit, and a first display unit.

The acquiring unit is configured to acquire parameter information of the M application programs and sequentially acquire application programs associated with the M application programs according to the parameter information of the M application programs.

The first analyzing unit is configured to acquire through analysis N application programs associated with the application program corresponding to the first application identification in a case that the first application identification is displayed in the first area of the display screen.

The first display unit is configured to acquire N object identifications of the N application programs and display the N object identifications in the second area of the display screen.

Preferably, the second display module includes a timing unit, a second analyzing unit, and a second display unit.

The timing unit is configured to start timing once the first application identification occurs in the first area to obtain a timed period.

The second analyzing unit is configured to acquire through analysis N application programs associated with the application program corresponding to the first application identification in a case that the timed period is greater than a preset threshold.

The second display unit is configured to acquire N object identifications of the N application programs and display the N object identifications in the second area of the display screen.

Preferably, the screening, according to the target application program, N application programs which meet a preset association condition from at least one of the application programs except the target application program in the electronic device includes: acquiring preset parameters of the target application program; and finding N application programs matching with the preset parameters of the target application program from at least one of the application programs except the target application program in the electronic device.

Preferably, the second display module includes a sorting unit and a third display unit.

The sorting unit is configured to sort the N object identifications according to a preset sorting rule.

The third display unit is configured to display the sorted N object identifications in the second area of the display screen.

The sorting unit is configured to: take times of usage in turn of the application programs corresponding to the object identifications and the first application program corresponding to the first application identification as historical usage records; sort the historical usage records corresponding to the N object identifications in order from largest to smallest.

The sorting unit is configured to: acquire preset parameters of the first application program corresponding to the first application identification; analyze matching degrees of the parameters of the application programs corresponding to the N object identifications with the preset parameters of the first application program; and sort the application programs corresponding to the N object identifications according to the matching degrees.

In summary, this embodiment provides an electronic device. A number of application programs being currently running in the electronic device may be displayed in a page of the task manager based on the instruction for calling a task manager, and each of the application programs may be associated with multiple application programs; and in a case that an application program being running is selected based on a selection operation in the page of the task manager, the application programs associated with the application program being running are directly displayed, which is convenient for a user to directly select an associated application program for operation, with a simple operation process, thereby improving the user's experience.

Various embodiments in the specification are described in a progressive manner, the differences from other embodiments are emphatically illustrated in each embodiment, and reference can be made to other embodiments for understanding the same or similar parts of the embodiments. The devices according to the embodiments correspond to the methods according to the embodiments and are described briefly, and the relevant portions may be found in the description of the methods.

The above description of the disclosed embodiments can enable those skilled in the art to practice or use the present disclosure. Multiple modifications to these embodiments are apparent for those skilled in the art, and the normal principles defined herein may be implemented in other embodiments without departing from the spirit or scope of the disclosure. Hence, the present disclosure is not limited to these embodiments disclosed herein but is to conform to the widest scope consistent with the principles and novel features disclosed herein.

1. A display method, comprising:
generating an instruction for calling a task manager according to an obtained first input operation;
displaying M application identifications of M application programs being running in queues on a display screen of an electronic device based on the instruction for calling a task manager, wherein M is a positive integer greater than or equal to 1; and
displaying N object identifications in a second area of the display screen in a case that a first application identification is displayed in a first area of the display screen, wherein the N object identifications correspond to N application programs, the N application programs are associated with the first application program corresponding to the first application identification, where N is a positive integer greater than or equal to 1;
wherein an application program corresponding to each of the M application identifications is called in response to a first triggering operation, and an application program corresponding to each of the N object identifications is called in response to a second triggering operation.

2. The method according to claim 1, wherein before the generating an instruction for calling a task manager according to an obtained first input operation, the method further comprises:
acquiring each of at least two of the application programs in the electronic device as a target application program;
screening, according to the target application program, N application programs which meet a preset association condition from at least one of the application programs except the target application program in the electronic device; and
associating the target application program with the N application programs.

3. The method according to claim 1, wherein after the displaying M application identifications of M application programs being running in queues on the display screen of the electronic device based on the instruction for calling a task manager and before the displaying N object identifications in the second area of the display screen, the method further comprises:
acquiring each of the M application programs as a target application program;
screening, according to the target application program, N application programs which meet a preset association condition from at least one of the application programs except the target application program in the electronic device; and
associating the target application program with the N application programs.

4. The method according to claim 1, wherein after the displaying M application identifications of M application programs being running in queues on the display screen of the electronic device based on the instruction for calling a task manager and before the displaying N object identifications in the second area of the display screen, the method further comprises:
adjusting a display area for the first application identification in the M application identifications into the first area of the display screen according to an obtained second input operation;
acquiring a target application program corresponding to the first application identification;
screening, according to the target application program, N application programs which meet a preset association condition from at least one of the application programs except the target application program in the electronic device; and
associating the target application program with the N application programs.

5. The method according to claim 2, wherein the displaying N object identifications in the second area of the display screen comprises:
acquiring parameter information of the M application programs;
sequentially acquiring application programs associated with the M application programs according to the parameter information of the M application programs;
obtaining through analysis N application programs associated with the application program corresponding to the first application identification in a case that the first application identification is displayed in the first area of the display screen; and
acquiring N object identifications of the N application programs and displaying the N object identifications in the second area of the display screen.

6. The method according to claim 2, wherein the displaying N object identifications in the second area of the display screen comprises:
starting timing once the first application identification occurs in the first area to obtain a timed period;
obtaining through analysis N application programs associated with the application program corresponding to the first application identification in a case that the timed period is greater than a preset threshold; and
acquiring N object identifications of the N application programs and displaying the N object identifications in the second area of the display screen.

7. The method according to any one of claim 2, wherein the screening, according to the target application program, N application programs which meet a preset association condition from at least one of the application programs except the target application program in the electronic device comprises:
acquiring preset parameters of the target application program; and
finding N application programs matching with the preset parameters of the target application program from at least one of the application programs except the target application program in the electronic device.

8. The method according to any one of claim 3, wherein the screening, according to the target application program, N application programs which meet a preset association condition from at least one of the application programs except the target application program in the electronic device comprises:
acquiring preset parameters of the target application program; and
finding N application programs matching with the preset parameters of the target application program from at least one of the application programs except the target application program in the electronic device.

9. The method according to any one of claim 4, wherein the screening, according to the target application program, N application programs which meet a preset association condition from at least one of the application programs except the target application program in the electronic device comprises:
acquiring preset parameters of the target application program; and
finding N application programs matching with the preset parameters of the target application program from at least one of the application programs except the target application program in the electronic device.

10. The method according to claim 1, wherein the displaying N object identifications in the second area of the display screen in a case that a first application identification is displayed in the first area of the display screen comprises:
sorting N object identifications according to a preset sorting rule; and
displaying the sorted N object identifications in the second area of the display screen.

11. The method according to claim 8, wherein the sorting N object identifications according to a preset sorting rule comprises:
taking times of usage in turn of the application programs corresponding to the object identifications and the first application program corresponding to the first application identification as historical usage records; and
sorting the historical usage records corresponding to the N object identifications in order from largest to smallest.

12. The method according to claim 8, wherein the sorting N object identifications according to a preset sorting rule comprises:
acquiring preset parameters of the first application program corresponding to the first application identification;
analyzing matching degrees of parameters of the application programs corresponding to the N object identifications with the preset parameters of the first application program; and
sorting the application programs corresponding to the N object identifications according to the matching degrees.

13. An electronic device comprising:
a display screen;
a sensor configured to obtain a first input operation; and
a processor connected to the display screen and the sensor and configured to generate an instruction for calling a task manager according to an obtained first input operation, display M application identifications of M application programs being running in queues on the display screen of the electronic device based on the instruction for calling a task manager, wherein M is a positive integer greater than or equal to 1, and display N object identifications in the second area of the display screen in a case that a first application identification is displayed in the first area of the display screen, wherein the N object identifications correspond to N application programs, the N application programs are associated with the first application program corresponding to the first application identification, where N is a positive integer greater than or equal to 1; wherein an application program corresponding to each of the M application identifications is called in response to a first triggering operation, and an application program corresponding to each of the N object identifications is called in response to a second triggering operation.

14. The electronic device according to claim 11, wherein the N object identifications are sorted according to a preset sorting rule and displayed in the second area of the display screen.

15. The electronic device according to claim 11, wherein the object identifications are not displayed in the second area of the display screen in a case that the application identifications are not displayed in the first area of the display screen.
